(19) United States
(12) Patent Application Publication
(10) Pub. No.: US 2023/0002622 A1
(43) Pub. Date: Jan. 5, 2023

(54) Fire-Retardant, Isocyanate-Free Coating Composition

(71) Applicant: Akzo Nobel Coatings International B.V., Amsterdam (NL)

(72) Inventors: Theodore CANTERBURY, Nashville, TN (US); Toolika Agrawal TOOLIKA, Amsterdam (NL)

(21) Appl. No.: 17/779,222

(22) PCT Filed: Nov. 23, 2020
(86) PCT No.: PCT/EP2020/083008

§ 371 Date: May 24, 2022

Related U.S. Application Data
(60) Provisional application No. 62/939,772, filed on Nov. 25, 2019.

(30) Foreign Application Priority Data
Dec. 13, 2019 (EP) 19215939.0

(51) Int. Cl. C09D 5/18; C09D 175/06; C09D 7/61

(52) U.S. Cl. CPC C09D 5/18; C09D 175/06; C09D 7/61

(57) ABSTRACT

The invention relates to a non-intumescent, waterborne fire-retardant coating composition comprising: (a) at least one binder resin having reactive functional groups comprising both hydroxyl and carboxylic groups, wherein the binder resin has an acid value lower than 40 mg KOH/g resin on solids and an OH value higher than 30 mg KOH/g resin on solids, (b) a crosslinker, capable of reacting with at least some of the functional groups of the binder resin (a), wherein the crosslinker contains a carbodiimide functionality, and (c) at least one fire retardant. The resulting coating has a good adhesion to a variety of substrates, prolonged pot-life, and complies with the requirements of fire resistance in aircraft industry.

### FIELD OF THE INVENTION

The present invention relates to a non-intumescent, waterborne fire-retardant coating composition, which is isocyanate-free (NISO).

### BACKGROUND

Fire-retardant coatings have been developed to control fire by various means, including raising the combustion temperature, reducing the rate of burning, reducing flame propagation and reducing smoke generation. Fire-retardant coatings are used in various fields and are in particular important in automotive and aircraft applications.

In commercial aircraft industry, aircraft interior components are typically sandwich structures comprising a core structural panel sandwiched between outer skins. Such interior components, like floors, sidewalls, panel coverings, window surrounds, partitions, bulkheads, ceilings and stowage compartments must withstand fire and emit minimum quantities of smoke and other toxic fumes during combustion.

Fire resistance standards in the United States are established by the Federal Aviation Administration. For aircraft interior components, Regulation FAR 25.853 includes flammability requirements for materials used in many aircraft operated in the United States. In particular, FAR 25.853 requires a flame time of the material not to exceed fifteen seconds, a burn length, which is not to exceed six inches, and a drip flame which is not to exceed three seconds.

Typically, fire-retardant coatings for aircraft applications are two-component (2K) coating compositions, often comprising a polyisocyanate-containing crosslinker. However, the use of isocyanate crosslinkers requires precautions in handling and using these materials due to their high toxicity. It is desired to decrease their use in coatings and look for alternative, less toxic analogues. Developing effective and isocyanate-free fire-retardant coatings that would meet the FAR rate of heat release, however, has been challenging.

It is desired to provide a waterborne, fire-retardant coating composition that is isocyanate-free. It is further desired that the coating composition is a two-component (2K) composition with a prolonged pot-life compared to conventional 2K formulations. It is further desired that the coating composition has good adhesion to various substrates and complies with the requirements of FAR 25.853.

### SUMMARY OF THE INVENTION

In order to address the above-mentioned desires, the present invention provides, in a first aspect, a non-intumescent, waterborne fire-retardant coating composition comprising:

(a) at least one binder resin having reactive functional groups comprising both hydroxyl and carboxylic groups, wherein the binder resin has an acid value lower than 40 mg KOH/g resin on solids and an OH value higher than 30 mg KOH/g resin on solids,

(b) a crosslinker, capable of reacting with at least some of the functional groups of the binder resin (a), wherein the crosslinker contains a carbodiimide functionality, and

(c) at least one fire retardant.

In another aspect, the present invention provides a method to coat a substrate, comprising applying the coating composition of the invention to a substrate and allowing the coating composition to cure.

In a further aspect, the invention also provides a substrate coating with the coating composition of the invention.

### DETAILED DESCRIPTION OF THE INVENTION

The coating composition according to the present invention is a non-intumescent, waterborne fire-retardant composition.

The coating composition is a non-intumescent coating composition. Intumescent coatings form a thick, highly insulating carbonaceous layer (char) on the surface of the substrate when exposed to heat or flame. This is achieved using a charring agent (e.g. polyhydric alcohol such as (di)pentaerythritol) and a blowing agent (such as melamine or urea). The present coating composition therefore contains no charring agent and no blowing agent.

The coating composition according to the present invention is waterborne, which means that the water is the main component of the liquid phase, in which the binder resin(s) are solved or dispersed. “Main component” means that it is present in a higher amount than any other solvent. “Solvent” is used here to include both water and organic solvents. Preferably, water constitutes at least 30 wt. %, more preferably at least 50 wt. %, yet preferably at least 60 wt. %, most preferably at least 70 wt. % of all the solvents.

Preferably, the coating composition is substantially isocyanate-free. “Substantially isocyanate-free” means that the coating composition does not comprise compounds with a reactive or reversibly blocked isocyanate functionality, or contains less than 1 wt. % of those, preferably less than 0.1 wt. %, based on the total weight of the coating composition. Most preferred, the coating composition does not comprise such compounds.

The coating composition comprises at least one binder resin, a crosslinker, at least one fire retardant and optionally other components, described in detail below.

### Binder Resin

The composition comprises at least one binder resin having reactive functional groups comprising both hydroxyl and carboxylic groups. Suitable binder resins can for example be selected from the group consisting of polyacrylates, polyesters, and polyurethanes. In some embodiments, the binder resin is a polyurethane. Preferably, it is provided in the form of an aqueous polyurethane dispersion (PUD).

Polyurethanes are typically prepared from at least one polyisocyanate and at least one polyol. The polyisocyanates, which can be used in the polyurethane synthesis, are known in this context to the skilled person, such as, for example, hexamethylene diisocyanate, octamethylene diisocyanate, decamethylene diisocyanate, dodecamethylene diisocyanate, tetradecamethylene diisocyanate, trimethylhexane diisocyanate, tetramethylhexane diisocyanate, isophorone diisocyanate, 2-isocyanatopropylcyclohexyl isocyanate, dicyclohexyl methane 2,4′-diisocyanate, dicyclohexylmethane 4,4′-diisocyanate, 1,4- or 1,3-bis(isocyanato-methyl)cyclohexane, 1,4- or 1,3- or 1,2-diisocyanatocyclohexane, 2,4- or 2,6-diisocyanato-1-methylcyclohexane, or mixtures of these polyisocyanates. Also dimers and/or trimers of the stated polyisocyanates can be used, more particularly, the uretdiones and isocyanurates of the aforementioned polyisocyanates, especially of the aforementioned diisocyanates, which are known per se and are available commercially.

Aliphatic isocyanates, such as isophorone diisocyanate (IPDI), and cycloaliphatic isocyanates, such as methylene dicyclohexyl diisocyanate (H12MDI), 1,3-cis bis(isocyanatomethyl)cyclohexane, 1,3-trans bis(isocyanatomethyl)cyclohexane, 1,4-cis bis(isocyanatomethyl)cyclohexane, 1,4-trans bis(isocyanatomethyl)cyclohexane and mixtures thereof are preferred.

The term “polyol” refers to any organic compound having two or more hydroxyl (—OH) groups that are capable of reacting with an isocyanate group. Polyols useful for preparation of polyurethane dispersions are generally known to a person skilled in the art. Suitable polyols may include polyether polyols, polyester polyols, polycarbonate polyols, and polylactone polyols. Preferred polyols are polyester polyols.

The binder resin preferably has a number-average molecular weight Mₙ from 2,000 to 10,000 g/mol, more preferably from 2,500 to 5,000. The binder resin preferably has a weight-average molecular weight M_{w} from 5,000 to 50,000 g/mol, more preferably from 10,000 to 30,000 g/mol. Molecular weights can be determined by gel permeation chromatography (GPC) using a polystyrene standard with tetrahydrofuran as the mobile phase.

The binder resin used in the present invention contains reactive functional groups, which comprise both hydroxyl and carboxylic groups. In order to disperse the binder resin in water, the carboxylic groups are preferably neutralized with a neutralizing agent. Examples of neutralization agents include ammonia and amines, such as di- and triethylamine, dimethylaminoethanol, diisopropanolamine, morpholines and/or N-alkylmorpholines.

Preferably, the acid value of the binder resin is less than 40 mg KOH/g resin solids, more preferably less than 30 mg KOH/g resin solids. Generally, the acid value is at least 5 mg KOH/g resin solids. The acid value in the context of the present invention is measured by potentiometric titration, e.g. in accordance with DIN EN ISO 3682.

The binder resin preferably has an OH value (hydroxyl value) higher than 30 mg KOH/g resin solids, preferably higher than 40 mg KOH/g resin solids, even more preferably higher than 50 mg KOH/g resin solids. Generally, the hydroxyl value is less than 100 mg KOH/g resin solids. The hydroxyl number can be measured by potentiometric titration using the TSI method, e.g. according to ASTM E1899-08.

The binder resin dispersion preferably has a solid content from 5 to 60 wt. %, more preferably from 10 to 50 wt. %.

Suitable commercial polyurethane dispersions are for example Daotan series from Allnex, particularly Daotan TW 1225/40 WANEP, TW 1252/42WA, TW 2229/40WANEP, TW 6425/40WA, TW 6464/36WA, TW 7000/40 WA, TW 7010/36WA.

The binder resin (a) is preferably present in an amount less than 20 wt. % of the solid content of the coating composition.

When all binder components are taken into account, including crosslinkers, additives and optionally present polymeric fire retardants, the total binder content is preferably less than 50 wt. %, more preferably less than 20 wt. % of the solid content of the coating composition. When only inorganic fire retardants are used, the total binder content can be as low as 5-15 wt. % on total solids. In some other cases, the total binder content can be 30-50 wt. %, e.g. when a polymeric fire retardant is used. The low binder content allows to include high amounts of fire retardants necessary for the fire resistance tests. Although in the present invention the binder only constitutes a small part of the solids of the coating composition, it is surprisingly sufficient for the excellent dry and wet adhesion of the final coating, as demonstrated in the examples.

### Crosslinker

The coating composition further comprises a crosslinker, capable of reacting with at least some of the functional groups of the binder resin described above. It is essential to the invention that the crosslinker is a non-isocyanate (NISO) crosslinker. Particularly, the crosslinker comprises a carbodiimide functionality. Carbodiimide crosslinker is preferably the only crosslinker in the coating composition.

The crosslinker can be a carbodiimide monomer, or preferably a polycarbodiimide. Polycarbodiimides are oligomers or polymers containing on average two or more carbodiimide groups. The carbodiimide group has the following general formula:

R₁N═C═NR₂

wherein R₁ and R₂ can be the same or different and are selected from hydrogen, aliphatic or aromatic groups. Aliphatic groups can for example be alkyl or cycloalkyl, comprising 1-20 carbon atoms. An example of such carbodiimide is dicyclohexyl carbodiimide. In some embodiments, the crosslinker can be multifunctional polycarbodiimide, which means that may comprise additional functional groups which have a reactivity towards functional groups in the resin or towards corresponding groups, i.e. by self-condensation or self-addition. Useful commercially available carbodiimides further include for instance polymeric carbodiimides of Stahl, such as Picassian® XL-701, Picassian® XL-702, Picassian® XL-725, Picassian® XL-732. Oligomeric, or polymeric carbodiimides are desirable, as they have lower toxicity. Preferably, a water-dispersible carbodiimide crosslinker is used.

The coating composition preferably comprises 0.1 to 20 wt. % of the carbodiimide crosslinker, more preferably 1 to 10 wt. % of the total weight of the composition.

### Fire Retardants

The coating composition further comprises at least one fire retardant. Any known fire retardant that can be incorporated in a waterborne coating composition can be used. Fire retardants can be inorganic and polymeric.

Fire retardants can also be divided into groups of halogen-containing and halogen-free fire retardants. Halogen-containing fire retardants include, for example, organochlorines such as chlorendic acid derivatives and chlorinated paraffins, organobromines such as decabromodiphenyl ether (decaBDE), decabromodiphenyl ethane, polymeric brominated compounds such as brominated polystyrenes, brominated carbonate oligomers (BCOs), brominated epoxy oligomers (BEOs), tetrabromophthalic anhydride, tetrabromobisphenol A (TBBPA) and hexabromocyclododecane (HBCD). Preferred halogen-containing fire retardants include polymeric brominated compounds, such as TexFRon 4002 available from ICL Industrial.

In alternative or in addition, it can be preferred to use a halogen-free fire retardant. In some embodiments it can be preferred that only halogen-free fire retardants are used and the whole coating composition is halogen-free. “Halogen-free” means that the composition is free of any halogen-containing compounds, i.e. fluorine-, chlorine-, bromine-, iodine-containing compounds.

Halogen-free fire retardants include magnesium hydroxide (MDH), aluminum hydroxide, zinc borate, zinc hydroxystannate, silicone resins, ammonium polyphosphate. Preferably, inorganic, halogen-free fire retardants are used. More preferably, aluminium hydroxides and/or zinc borate are used.

In a preferred embodiment, a mixture of fire retardants is used. Particularly, a mixture of aluminium hydroxide and zinc borate is preferred. Optionally, this mixture can be used together with a halogen-containing fire retardant.

The total content of fire retardants is preferably in the range 40-90 wt. %, more preferably 50-80 wt. % of the total solids content of the coating composition. This includes both inorganic and polymeric fire retardants, if used.

In some embodiments, the inorganic fire retardant to binder ratio is preferably in the range 2 to 6. Inorganic fire retardant to binder ratio is the weight ratio of the sum of all inorganic fire retardants to the sum of all binder components, which include resins, crosslinkers and additives solids. However, it is also possible to increase the amount of binder and have an inorganic fire retardant to binder ratio as low as 0.1-2, while still passing the necessary heat release rate tests.

### Other Components

The coating composition preferably contains at least one pigment to impart color to the coating composition. Suitable pigments can be inorganic or organic. Examples of suitable inorganic coloring pigments are white pigments such as titanium dioxide, zinc white, zinc sulfide, or lithopone; black pigments such as carbon black, iron manganese black or spinel black; chromatic pigments such as chromium oxide, chromium oxide hydrate green, cobalt green, or ultramarine green, cobalt blue, ultramarine blue, or manganese blue, ultramarine violet or cobalt violet and manganese violet, red iron oxide, cadmium sulfoselenide, molybdate red or ultramarine red; brown iron oxide, mixed brown, spinel phases, and corundum phases, or chromium orange; or yellow iron oxide, nickel titanium yellow, chromium titanium yellow, cadmium sulfide, cadmium zinc sulfide, chromium yellow, or bismuth vanadate.

Examples of suitable organic coloring pigments are monoazo pigments, disazo pigments, anthraquinone pigments, benzimidazole pigments, quinacridone pigments, quinophthalone pigments, diketopyrrolopyrrole pigments, dioxazine pigments, indanthrone pigments, isoindoline pigments, isoindolinone pigments, azomethine pigments, thioindigo pigments, metal complex pigments, perinone pigments, perylene pigments, phthalocyanine pigments, or aniline black.

The pigment content is preferably in the range from 1 to 80 wt. %, more preferably in the range from 5 to 60 wt. %, more preferably in the range 10-50 wt. %, based on the total weight of the coating composition.

Examples of fillers are chalk, calcium sulfate, barium sulfate, silicates such as talc or kaolin, silica, oxides and hydroxides such as aluminum (hydr)oxide or magnesium (hydr)oxide, clays, nano silica, borates, glass beads, or organic fillers such as textile fibers, cellulose fibers, polyethylene fibers, or polymer powders.

Preferably, the inorganic content of the composition according to the present invention is in the range 40-95 wt. %, more preferably 50-90 wt. %, based on the total solids weight. Inorganic content is the content of all solid inorganic components (including pigments and inorganic fire retardants), drawn to the total solids weight of the coating composition. High inorganic content is usually necessary to fulfill the heat release requirements. This can be challenging for maintaining good coating properties such as adhesion, as high inorganic content corresponds to lower binder resin content.

Preferably, the pigment-to-binder (P/B) ratio of the composition is in the range 0.5-10, more preferably in the range 5-8. In some embodiment the P/B ratio of 0.5-2 can be used, e.g. in case of polymeric fire retardants. P/B ratio is the weight ratio of the sum of the inorganic pigments and fillers to the binder solids, which include resin(s), crosslinker(s) and additives.

The coating composition can further comprise conventional additives, such as defoamers, rheology modifiers, pigments, pH stabilizer, flow agents, levelling agents, wetting agents, matting agents, antioxidants, emulsifiers, stabilizing agents, inhibitors, catalysts, thickeners, thixotropic agents, impact modifiers, expandants, process aids, and mixtures of the aforementioned additives. The amount of such additives is preferably from 0.01 to 25 wt. %, more preferably 0.05 to 15 wt. %, most preferably 0.1 to 10 wt. %, based on the total weight of the coating composition.

Although the coating composition according to the present invention is waterborne, this does not exclude small amounts of organic solvents that can be present. The coating composition according to the present invention may contain at least one organic solvent, for example in an amount less than 40 wt. %, preferably less than 30 wt. %, more preferably less than 20 wt. % of the total solvent weight (including water). Based on the total weight of the coating composition, the organic solvent content is preferably less than 30 wt. %, more preferably less than 20 wt. %, yet more preferably less than 15 wt. %. In some embodiments, the organic solvent content can be at least 0.5 wt. %, more preferably at least 1 wt. %, yet more preferably at least 5 wt. %, based on the total weight of the coating composition. In other embodiments the solvent content can be at least 15 wt. %, or at least 20 wt. %, or at least 30 wt. % based on the total weight of the coating composition.

Suitable organic solvents are preferably those, which can be mixed with water. Particularly preferred class is glycol ethers. These include ethylene glycol monomethyl ether, ethylene glycol monoethyl ether, ethylene glycol monopropyl ether, ethylene glycol monoisopropyl ether, ethylene glycol monobutyl ether, ethylene glycol monophenyl ether, ethylene glycol monobenzyl ether, propylene glycol methyl ether, diethylene glycol monomethyl ether, diethylene glycol monoethyl ether, diethylene glycol mono-n-butyl ether, dipropyleneglycol methyl ether. Preferred solvents include propylene glycol n-propyl ether, propylene glycol n-butyl ether, dipropylene glycol n-butyl ether, di(propylene glycol) methyl ether, ethylene glycol monobutyl ether.

The solids content of the coating composition of the invention is preferably from 30 to 85 wt. %, more preferably 35 to 80 wt. %, more preferably from 40 to 75 wt. %.

The coating composition according to the invention can be prepared by mixing and dispersing and/or dissolving the respective components of the coating composition described above. This can be done by using conventional means, e.g. high-speed stirrers, stirred tanks, agitator mills, dissolvers, compounders, or inline dissolvers.

The coating composition is preferably formulated as a two-component (2K) coating composition. “Two-component” means that it is provided in the form of two components, which are stored in separate containers after manufacture, and which are only mixed shortly before the application. Preferably, the crosslinker (b) is stored in a separate component from the component comprising the binder resin (a).

The coating composition according to the invention can be used as a single coating applied directly to a substrate, or in multilayer systems, particularly as a primer, filler or a surfacer. In a particularly preferred embodiment, the coating composition is used as a filler or a primer, applied directly to a substrate. The primer can be overcoated by further coating layers, preferably waterborne coatings.

The invention further provides a method to coat a substrate with the coating composition described above and a substrate coated with the coating composition. Preferably, the coated substrate is an automobile or aircraft part. The method comprises applying and subsequently allowing the coating composition according to the invention to cure to a substrate.

The coating composition can be applied to the substrates typically used for interior applications of airplanes or trains. The substrate is preferably selected from the group consisting of plastic, composite, metal substrates. Particularly, the substrates can be plastics such as polycarbonates, polyetherimide (PEI), polyether ether ketone (PEEK), polyphenylsulfone (PPSU), composites such as honeycomb composites, phenolic glass composites, laminates (e.g. PVF laminates), pre-treated metal (e.g. chromated aluminum). An example of a honeycomb composite is NOMEX® aramid paper from DuPont widely used in aircraft structural panels because of its high strength to weight ratio and resistance to fatigue failures.

The coating composition according to the invention can be applied to the substrate by any suitable means known in the art, e.g. spraying, brushing, rolling, or dipping.

The coating composition can be cured at ambient conditions, such as room temperature (15-30° C.), for example for 2-4 hours. However, the coating can also be cured at an elevated temperature, e.g. in an oven 80-90° C. for 30-60 min. A skilled person is able to find suitable temperature and curing time.

The coating composition of the present invention preferably has a low VOC (volatile organic content), particularly less than 250 g/l, more preferably less than 200 g/l. VOC can be calculated as the sum of all volatile organic components in the coating composition. Low VOC allows for painting inside aircraft cabins with minimal protective equipment and can be applied with spray or brushed or rolled on.

The coating composition of the present invention has a long pot-life (>7 hours) and low heat release during combustion when compared to state-of-the-art isocyanate-containing formulation. The coating further shows good adhesion to a variety of substrates (composites, polycarbonate, aluminium), while maintaining excellent heat release when fire retardants such as zinc borate are used at high concentration.

Without wishing to be bound by a particular theory, it is believed that carbodiimide crosslinkers react with the carboxylic groups of the binder resin. It is however surprising that good coating properties are achieved even when the binder resin has a relatively low acid value (lower than 40 mg KOH/g resin on solids) and considerable amount of free OH groups, which are generally considered to compromise wet adhesion properties by making the surface hydrophilic. As shown further in the examples, the coating compositions according to the invention have surprisingly good adhesion, even after immersion in water.

### EXAMPLES

### Abbreviations

Daotan 6425-40WA—aqueous, solvent free polyester-based polyurethane dispersion from Allnex, solid content 40 wt. % in water, OH value 55 mg KOH/g resin on solids, acid value 28.7 mg KOH/g resin on solids, Mn 3100-3500, Mw 15000-17000.

DMEA—dimethylethanol amine

TexFRon 4002—brominated polymeric fire retardant from ICL Industrial

Easaqua M501—water-dispersible aliphatic polyisocyanate, HDI-trimer, by Vencorex

Picassian XL-701—multifunctional polycarbodiimide crosslinker from Stahl, 50 wt. % solids

### Example 1 Preparation of Coating Compositions

Coating compositions were prepared according to Table 1. The ingredients are mixed in a disperser to obtain a homogeneous composition. The amounts are given as parts by weight. Comparative composition A contains a polyisocyanate as a crosslinker, comparative composition C contains both a carbodiimide and a polyisocyanate. Compositions B and D are according to the invention and only contains carbodiimide as a crosslinker. Composition D contains in addition a polymeric fire retardant.

TABLE 1

| Ingredient | Description | A | B | C | D |
|---|---|---|---|---|---|
| Daotan 6425-40WA | Resin | 12.43 | 11.19 | 12.25 | 12.01 |
| DMEA | Neutralizer | 0.08 | 0.09 | 0.08 | 0.10 |
| Additives* | | 1.67 | 3.80 | 1.64 | 1.66 |
| Propoxy-propanol | Solvent | 3.61 | 1.27 | 3.55 | 1.36 |
| Dowanol DPNB | Solvent | 2.92 | 0.74 | 2.88 | 0.80 |
| Water | Solvent | 12.13 | 16.23 | 12.28 | 15.68 |
| Talc | Filler | 4.04 | 4.12 | 3.98 | 4.42 |
| Carbon black | Pigment | 0.32 | 0.04 | 0.32 | 0.05 |
| Titanium dioxide | Pigment | 12.57 | 11.85 | 12.38 | 12.72 |
| Aluminium hydroxide | Inorganic FR | 12.92 | 11.71 | 12.72 | 12.57 |
| Zinc borate hydrate | Inorganic FR | 33.03 | 31.70 | 32.05 | 11.09 |
| TexFRon 4002 | Polymeric FR | 0 | 0 | 0 | 22.20 |
| Easaqua M501 | Crosslinker | 4.29 | 0 | 2.03 | 0 |
| Picassian XL-701 | Crosslinker | 0 | 7.25 | 3.85 | 5.34 |
| Solids content, wt. % | | 73.02 | 68.92 | 71.17 | 71.45 |
| Pigment-to-binder ratio | | 6.25 | 6.74 | 6.37 | 1.34 |
| Inorganic FR pigment- | | 4.57 | 4.88 | 4.64 | 0.78 |
| to-binder ratio | | | | | |
| Inorganic content on | | 86.11 | 86.98 | 86.34 | 57.16 |
| solids, wt. % | | | | | |
| Total binder content | | 13.78 | 12.90 | 13.55 | 42.71 |
| on solids, wt. % | | | | | |

*commercial defoamers, pigment dispersants, rheology modifiers

Pigment-to-binder (P/B) ratio is the weight ratio of the sum of the inorganic pigments and fillers to the binder solids, which include resin(s), crosslinker(s) and additives. Inorganic FR pigment-to-binder ratio is weight ratio of the sum of the inorganic fire retardants to the binder solids. Inorganic content is calculated as the weight ratio of the sum of inorganic compounds to the total solids. Total binder content on solids is the weight ratio of the total binder solids to total solids.

### Example 2

### Adhesion Tests

Adhesion tests were performed on the substrates phenolic/glass sandwich (Danner BMS8-226) and polycarbonate (Lexan™ by SABIC). The adhesion panels of about 75 mm by 150 mm were prepared for coating by sanding or wiping with solvent (isopropanol). The coating compositions of Example 1 were spray applied as primers using a HVLP cup gun (SATA 3000, 1.4 mm nozzle diameter) to the desired dry film thickness (50-100 μm). After primer coating, the samples were cured in an oven at 80-90° C. for 30-60 minutes. Some primed panels were further coated with a commercial Intura 8001 semi-gloss topcoat, available from AkzoNobel. After topcoat application, the panels are cured at controlled temperature (25° C.) and humidity (50% RH) for 24 h.

Dry adhesion was tested by making several scribes in the coated panel and applying and removing a masking tape to the scribed coating. Wet adhesion was tested after immersing the coated panel into water for 24 hours. Adhesion is evaluated on a scale of 1 to 10, wherein 1—all of coating is gone, 10—no loss of coating.

TABLE 2

| | | A | B | C | D |
|---|---|---|---|---|---|
| Dry adhesion | | | | | |
| Danner BMS8-226 | Primer | 10 | 10 | 10 | 10 |
| Danner BMS8-226 | Primer + Topcoat | 10 | 9 | 10 | 10 |
| Polycarbonate | Primer | 10 | 10 | 10 | 10 |
| Polycarbonate | Primer + Topcoat | 10 | 9 | 10 | 10 |
| Wet adhesion | | | | | |
| Danner BMS8-226 | Primer | 10 | 8 | 9 | 10 |
| Danner BMS8-226 | Primer + Topcoat | 9 | 8 | 7 | 9 |
| Polycarbonate | Primer | 10 | 9 | 10 | 9 |
| Polycarbonate | Primer + Topcoat | 9 | 9 | 3, 9 | 8 |
| | | | | after 24 h | |

As can be seen in Table 2, the coating compositions with only carbodiimide crosslinking agent (B and D) have surprisingly good adhesion results even after water immersion, comparable with those containing polyisocyanate crosslinkers. Traditionally, it has been believed that good wet adhesion can only be achieved by using polyisocyanate crosslinkers.

### Example 3

### Heat Release Tests

The coating compositions prepared in Example 1 were applied to uncoated phenolic glass composite (Airbus Type 1) as a primer. The heat release panels are 150 mm by 150 mm in lateral dimensions. Coating application was the same as in Example 2.

The heat release data provided was measured using AkzoNobel's Ohio State University (OSU) heat release apparatus, which conforms to the FAR 25.853 requirements. In the standard FAR 25 procedure, a sample is inserted into the combustion chamber of the OSU apparatus and subjected to a calibrated radiant heat flux of 35 kW/m² and an impinging pilot flame. Room temperature air is forced through the combustion chamber and exits through the exhaust duct at the top of the apparatus where a thermopile senses the temperature of the exhaust gases. Heat release rate (HRR) during the test is deduced from the sensible enthalpy rise of the air flowing through the combustion chamber using the temperature difference between the exhaust gases and the ambient incoming air to calculate the amount of heat released by burning after suitable calibration using a metered methane diffusion flame.

The results are shown in Table 3. The results are average of two burns.

TABLE 3

| | Film | Peak HRR, | Total HRR, | |
|---|---|---|---|---|
| | weight, g | kW/m² | kW-min/m² | Pass/Fail* |
| Composition A | 5.03 | 31.71 | 39.57 | Pass |
| Composition B | 4.58 | 28.44 | 32.97 | Pass |
| Composition C | 3.44 | 26.23 | 30.13 | Pass |
| Composition D | 4.54 | 27.80 | 31.77 | Pass |

*Pass/Fail refers to requirement of Peak HRR < 45 kW/m² and Total HRR < 45 kW/m²

This example shows that the inventive coatings from isocyanate-free coating compositions are able to pass the heat release rate requirements.

### Example 4

### Heat Release Tests on Primer+Topcoat

Same as Example 3, but further coated with a commercial Intura 8001 semi-gloss topcoat, available from AkzoNobel. The results are shown in Table 4.

TABLE 4

| | Total film | Peak HRR, | Total HRR, | |
|---|---|---|---|---|
| | weight, g | kW/m² | kW-min/m² | Pass/Fail* |
| A + topcoat | 7.16 | 56.79 | 56.15 | Fail |
| B + topcoat | 6.06 | 53.53 | 38.86 | Pass |
| C + topcoat | 7.32 | 56.97 | 48.95 | Fail |
| D + topcoat | 6.99 | 50.43 | 38.97 | Pass |

*Pass/Fail refers to requirement of Peak HRR < 55 kW/m² and Total HRR < 55 kW/m²

This example shows that the inventive coatings from isocyanate-free coating compositions and topcoats are able to pass the heat release rate requirements.

### Example 5

### Pot-Life

The pot-life is tested using a Krebs Stormer viscometer and reported in Krebs units (K.U.). The procedure for the analysis is detailed in ASTM D562-10 (2018). The samples were approximately 200 mL and were tested in an 80 mm diameter cup. Some paint mixtures do not show an increase in viscosity at the end of the pot-life. Therefore, the primers were also spray applied (if sprayable) after a given time (9 h, 18 h, 24 h) and the applied paint tested to confirm adhesion to substrate and water resistance. Additionally, a topcoat was applied to the cured primer and tested to confirm recoatability and adhesion. The results are shown in Table 5.

TABLE 5

| Time (h) | Composition A | Composition B |
|---|---|---|
| 0 | 64.3 | 84.5 |
| 1 | Gel (>140 K.U.) | 79.0 |
| 2 | — | 78.0 |
| 3 | — | 77.4 |
| 4 | — | 77.2 |
| 5 | — | 77.4 |
| 6 | — | 78.2 |
| 7 | — | 79.7 |

As can be seen from the above table, the pot-life of the coating composition according to the invention B is considerably longer than of the comparative, isocyanate-containing coating composition A. The short pot-life of the comparative coating composition is likely to be attributed to the high Zn borate content as Zn can serve as a catalyst for the urethane reaction

1. A non-intumescent, waterborne, isocyanate-free fire-retardant coating composition comprising:
(a) at least one binder resin having reactive functional groups comprising both hydroxyl and carboxylic groups, wherein the binder resin has an acid value lower than 40 mg KOH/g resin on solids, and an OH value higher than 30 mg KOH/g resin on solids,
(b) a crosslinker, capable of reacting with at least some of the functional groups of the binder resin (a), wherein the crosslinker contains a carbodiimide functionality, and
(c) at least one fire retardant,
said composition having the inorganic content in the range 50-90 wt. % based on the solid content of the coating composition.

2. The composition according to claim 1, wherein the binder resin (a) is a polyurethane.

3. The composition according to claim 1, wherein the binder resin (a) is present in an amount less than 20 wt. % of the solids content of the coating composition.

4. The composition according to claim 1, having pigment-to-binder ratio in the range 0.5-10.

5. The composition according to claim 1, wherein the fire retardant is selected from the group consisting of aluminium hydroxide, zinc borate and mixtures thereof.

6. The composition according to claim 1, having a VOC content less than 200 g/L.

7. A method to coat a substrate, comprising applying the coating composition according to claim 1 to a substrate and allowing the coating composition to cure.

8. A substrate coated with the coating composition according to claim 1.

9. The substrate according to claim 8, being plastic, composite or a metal substrate.
